(19) United States
(12) Patent Application Publication
(10) Pub. No.: US 2013/0047369 A1
(43) Pub. Date: Feb. 28, 2013

(54) Air blower assembly

(71) Applicants: Young Keun Heo, Hwaseong (KR); Young Hoon Kwak, Suwon (KR)

(72) Inventors: Young Keun Heo, Hwaseong (KR); Young Hoon Kwak, Suwon (KR)

(73) Assignee: SAMSUNG ELECTRO-MECHANICS CO., LTD., Suwon (KR)

(21) Appl. No.: 13/373,396

(22) Filed: Nov. 14, 2011

(30) Foreign Application Priority Data
Aug. 31, 2011 (KR) 10-2011-0088029

(51) Int. Cl. B08B 5/02

(52) U.S. Cl. 15/405

(57) ABSTRACT

There is provided an air blower assembly removing foreign objects, or the like, attached to an object to be cleaned by blowing high pressure air. The air blower assembly includes: a frame; and a nozzle fixed to the frame and having one end to be connected to the blower to remove foreign objects by air blowing to the other end, wherein the nozzle is an elastic body that moves freely by air blowing.

### CROSS-REFERENCE TO RELATED APPLICATIONS

This application claims the priority of Korean Patent Application No. 10-2011-0088029 filed on Aug. 31, 2011, in the Korean Intellectual Property Office, the disclosure of which is incorporated herein by reference.

### BACKGROUND OF THE INVENTION

1. Field of the Invention

The present invention relates to an air blower assembly removing foreign objects, or the like, attached to an object to be cleaned, by blowing high pressure air thereon.

2. Description of the Related Art

According to the related art, various types of foreign object removal units have been used in various components, or an assembly line, or the like, of components, in order to remove foreign objects (such as dust particles) present in products.

Particularly, small-sized components or small-sized products have a significantly small size, such that it may not be easy to remove foreign objects attached thereto. For example, foreign objects that are to be removed during the assembling of a motor base assembly (MBA) in a hard disk drive (HDD) motor assembly process generally have a size of 1 to 500 μm. However, an MBA structure is a relatively complex structure, rather than a simple planar structure, such that it is not easy to remove foreign objects therefrom merely through air blowing, or the like. In the case that the foreign objects are not removed, defects are caused in final complete products. Therefore, it is very important to remove foreign objects.

Accordingly, according to the related art, a method of blowing high pressure air has been used in order to remove the foreign objects . In this air blowing method, in which a laminar air flow is generated, a high pressure air blowing speed should be secured in order to remove the foreign objects. However, in actuality, it may not be easy to blow air at a speed sufficient to remove the foreign objects attached to the small-sized component, such that it is not easy to remove the foreign objects.

Therefore, a unit capable of more efficiently removing foreign objects, beyond simply blowing air at a high speed, has been demanded.

### SUMMARY OF THE INVENTION

An aspect of the present invention provides an air blower assembly having increased efficiency in removing foreign objects attached to an object to be cleaned, by blowing high pressure air thereon.

According to an aspect of the present invention, there is provided an air blower assembly including: a frame; and a nozzle fixed to the frame and having one end to be connected to the blower to remove foreign objects by air blowing to the other end, wherein the nozzle is an elastic body that moves freely by the air blowing.

The air blower assembly may further include a length controlling unit controlling a length at which the nozzle moves.

The length controlling unit may be a sliding member that has the nozzle fixedly mounted thereon and is mounted in the frame so as to move in a length direction of the nozzle.

The length controlling unit may include the sliding member including a through-hole having the nozzle inserted thereinto while penetrating therethrough, wherein the nozzle is inserted into the through-hole while penetrating therethrough in a state in which it is fixed to the frame and only the sliding member moves in a length direction of the nozzle.

The air blower assembly may further include a guide unit guiding the nozzle along a path.

The guide unit may be a straight line guide mounted in the frame and including a guide hole having a diameter corresponding to that of the nozzle and a predetermined width at which the nozzle moves, such that the nozzle moves in a state in which it is seated in the guide hole.

The guide unit may be a random guide mounted in the frame and including a guide hole having a diameter larger than that of the nozzle, such that the nozzle moves in a state in which it is seated in the guide hole.

According to another aspect of the present invention, there is provided a foreign object removing device including: a rail transferring an object to be cleaned; and the air blower assembly as described above mounted to blow air toward the object to be cleaned being transferred by the rail.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a foreign object removing device according to an embodiment of the present invention;

FIG. 2 is a schematic perspective view of an air blower assembly according to an embodiment of the present invention;

FIG. 3 is a schematic perspective view of a first embodiment of a length controlling unit according to the present invention;

FIG. 4 is a schematic perspective view of a second embodiment of a length controlling unit according to the present invention;

FIG. 5 is a schematic perspective view of a first embodiment of a guide unit according to the present invention; and

FIG. 6 is a schematic perspective view of a second embodiment of a guide unit according to the present invention.

### DETAILED DESCRIPTION OF THE INVENTION

Embodiments of the present invention will now be described in detail with reference to the accompanying drawings.

The embodiments of the present invention may be modified in many different forms and the scope of the invention should not be seen as being limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

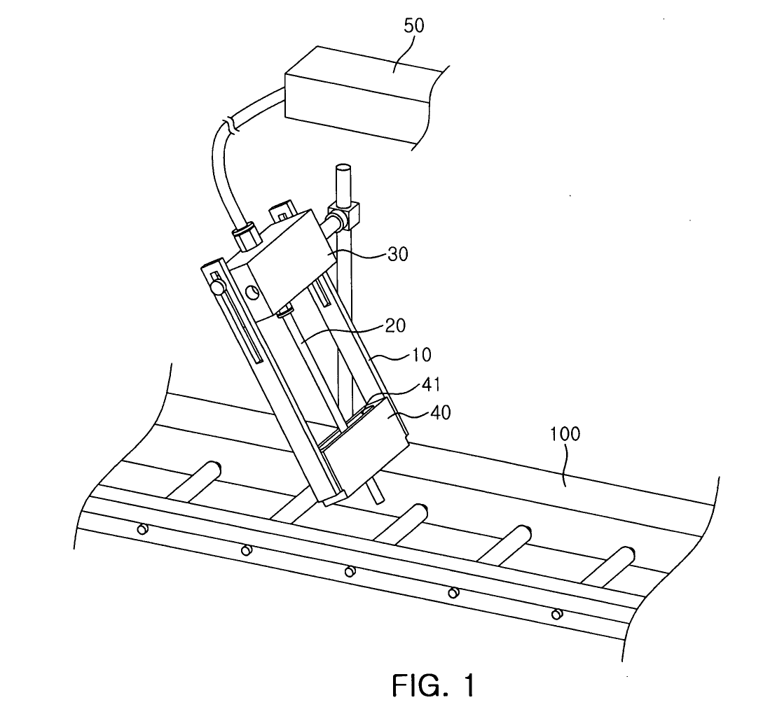

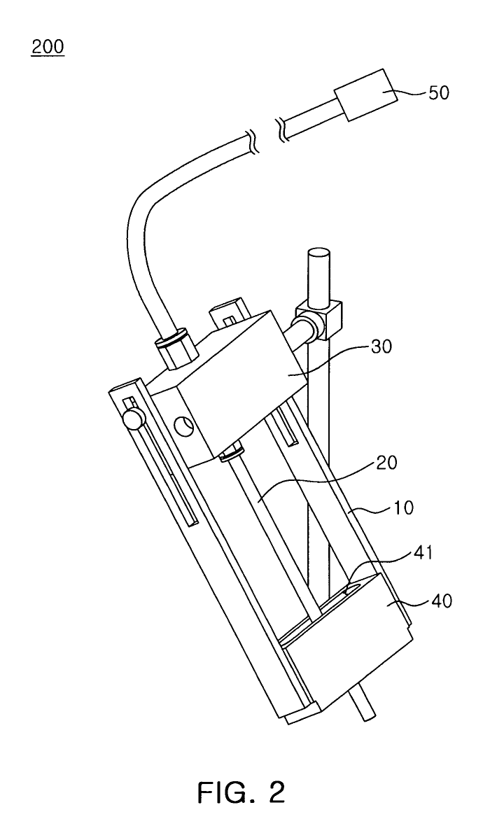

FIG. 1 is a schematic perspective view of a foreign object removing device according to an embodiment of the present invention; and FIG. 2 is a schematic perspective view of an air blower assembly according to an embodiment of the present invention.

Referring to FIGS. 1 and 2, the foreign object removing device, according to the embodiment of the present invention, may include a rail 100 transferring an object to be cleaned and an air blower assembly 200 mounted to blow air toward the object to be cleaned being transferred by the rail 100.

As the rail 100, a rail generally used in a component assembling line may be used, and various types of rails 100 designed to only be used in the manufacturing of a specific product may be used. That is, various types of rails mounted to transfer the object to be cleaned may be used. Furthermore, although a case in which the air blower assembly 200 is fixed, and the object to be cleaned, seated on the rail 100, is cleaned by air blowing while being transferred by the rail 100 will be described, the present invention is not limited thereto. That is, a case in which the air blower assembly 200 is transferred by the rail, a slide, or the like, and the object to be cleaned is fixed, is included in the spirit and scope of the present invention.

The air blower assembly 200 has one end that is to be connected to a blower to receive high pressure air and has the other end that moves freely to blow air toward the object to be cleaned, thereby removing foreign objects attached to the object to be cleaned.

Here, the air blower assembly 200 may be used using a method more advanced than that of a simple method of removing foreign objects attached to the object to be cleaned by controlling an air blowing speed or pressure in consideration of sizes, attachment strength, or the like, of the foreign objects. That is, an air blowing pressure or speed of the blower may be constantly fixed (the air blowing pressure or speed of the blower may also be changed as needed), and an air blowing structure of a nozzle connected to the blower to blow the air maybe changed to allow the blown air to flow while being vibrated, whereby a foreign object removal effect may be significantly increased.

That is, the foreign object removing device according to the embodiment of the present invention allows turbulence to be generated in the blown air using the nozzle having elasticity without adding a specific component, whereby foreign object removal efficiency may be increased. In other words, the foreign object removing device according to the embodiment of the present invention includes a blower 50 and a nozzle 20 fixed to a frame 10 and having one end connected to the blower to remove the foreign objects by air blowing to the other end, wherein the nozzle 20 may include the air blower assembly provided as an elastic body that moves freely by air blowing, such that the turbulence is naturally generated by the free movement of the nozzle 20 at the time of the air blowing.

When fluid, gas, or the like, is blown using the nozzle (a general rubber hose, or the like) having elasticity, a distal end of the nozzle from which the fluid, the gas, or the like is blown, irregularly moves in all directions in a state in which there is no separate fixing device, such that turbulence is generated in the blown fluid or gas. According to the embodiment of the present invention, this turbulence generation principle may be applied to the blowing device, whereby the air may be efficiently blown without adding a separate device. In addition, a forced frequency may be controlled by controlling a length at which the nozzle may freely move. Further, a guide unit guiding the movement of the nozzle may be provided, whereby the movement of the nozzle to a specific position may be controlled.

Vibrations occur due to instability of the air generated in the nozzle having elasticity. As the vibrations increase in magnitude, a forced frequency of the air gradually approaches a natural frequency of a tube. When the forced frequency of the air approaches the natural frequency of the tube, a resonance phenomenon occurs. A frequency at which the resonance phenomenon occurs is called a resonant frequency and a vibration width when the resonance phenomenon occurs has a relative maximum value. The vibrations at a predetermined frequency generated at this time may be effective in removing foreign objects jammed in a narrow gap. In addition, as a result of an actual foreign object removal test, it may be appreciated that a foreign object removal rate may be improved by 25 to 30% as compared to a blower according to the related art.

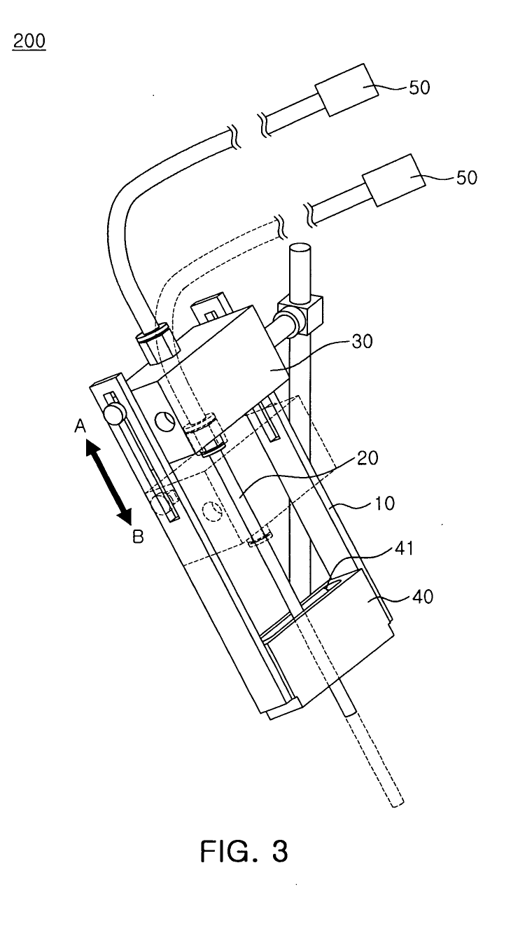

Hereinafter, embodiments of an air blower assembly according to an embodiment of the present invention will be described in more detail with reference to FIGS. 3 through 6.

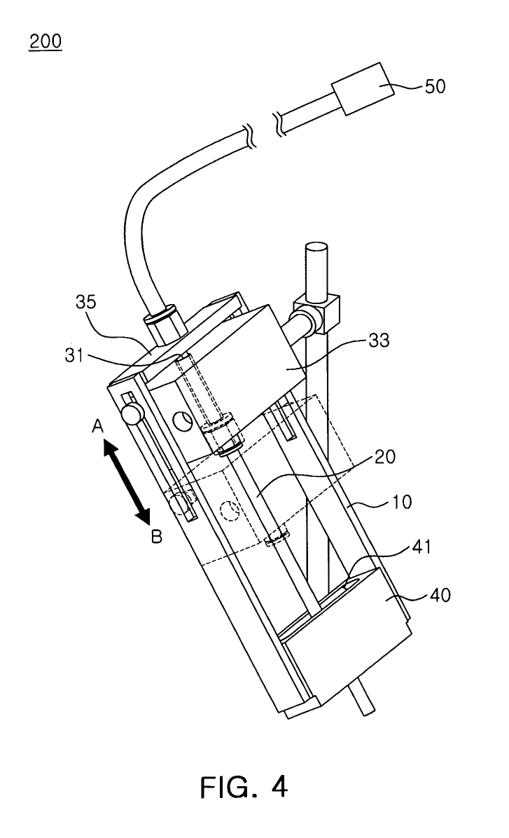

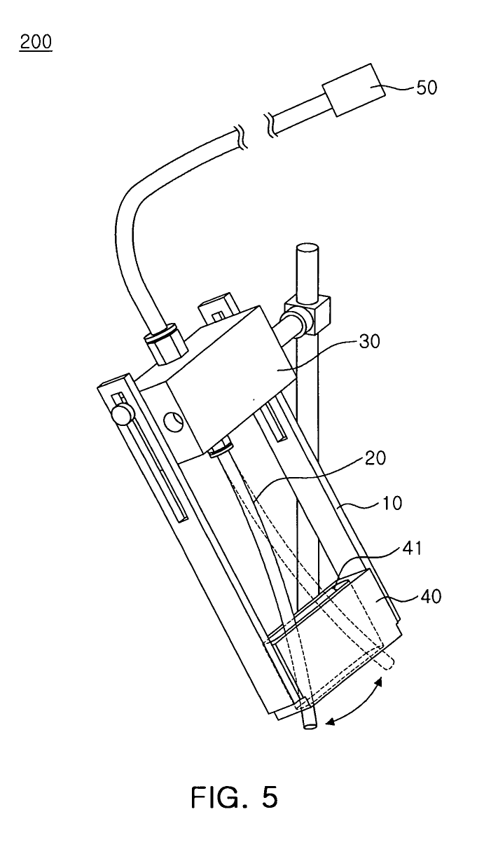

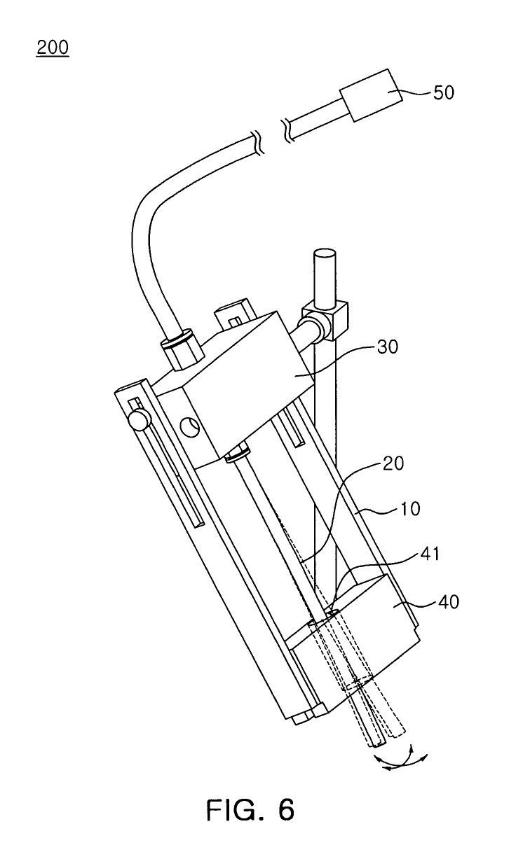

FIG. 3 is a schematic perspective view of a first embodiment of a length controlling unit according to the present invention; FIG. 4 is a schematic perspective view of a second embodiment of a length controlling unit according to the present invention; FIG. 5 is a schematic perspective view of a first embodiment of a guide unit according to the present invention; and FIG. 6 is a schematic perspective view of a second embodiment of a guide unit according to the present invention.

The air blower assembly according to an embodiment of the present invention may include a blower 50 and a nozzle 20 fixed to a frame 10 and having one end connected to the blower to remove foreign objects by air blowing to the other end, wherein the nozzle 20 may be an elastic body that moves freely by air blowing.

Referring to FIG. 3, a first embodiment of a length controlling unit according to the present invention is disclosed. That is, the length controlling unit of the air blower assembly according to the present invention may control a movement range of the nozzle 20 to control a frequency of the nozzle 20, thereby allowing air to be appropriately blown.

The length controlling unit 30 according to the first embodiment may be a sliding member that has the nozzle 20 fixedly mounted thereon and is mounted in the frame 10 so as to move in a length direction of the nozzle 20. That is, the length controlling unit 30 may move together with the nozzle 20 in the length direction of the nozzle in a state in which it has the nozzle 20 mounted therein, thereby changing a length of the nozzle.

Referring to FIG. 3, the length of the nozzle 20 protruded downwardly from the guide unit 40 may be longer in the case in which the length controlling unit 30 is positioned in a portion ‘B’ than in the case in which the length controlling unit 30 is positioned at a portion ‘A’, such that the range of the nozzle 20 may be enlarged.

Referring to FIG. 4, a second embodiment of the length controlling unit according to the present invention is disclosed. That is, the length controlling unit of the air blower assembly according to an embodiment of the present invention may control a movement range of the nozzle 20 to control a frequency of the nozzle 20, thereby allowing air to be appropriately blown.

The length controlling unit 30 according to the second embodiment may include a sliding member 33 including a through-hole 31 having the nozzle 20 inserted thereinto while penetrating therethrough, wherein the nozzle 20 is inserted into the through-hole 31 while penetrating therethrough in a state in which it is fixed to the frame 10, and only the sliding member 33 may move in a length direction of the nozzle. That is, the nozzle 20 may be fixedly mounted to the frame 10 and only the sliding member 33, except for the nozzle 20, moves in the length direction of the nozzle, such that the range of nozzle 20 may be changed. Here, the nozzle 20 may be fixed to the frame 10 by a separate nozzle fixing unit 35.

Referring to FIG. 4, the entire range of the nozzle 20 may become smaller in the case in which the sliding member 33 is positioned at a portion ‘B’ than in the case in which the sliding member 33 is positioned at a portion ‘A’ , such that the range of the nozzle 20 while moving may be relatively smaller.

Referring to FIG. 5, a first embodiment of the guide unit according to the present invention is disclosed. That is, the guide unit of the air blower assembly according to the embodiment of the present invention may accurately guide the nozzle 20 to a portion of the object to be cleaned, by controlling a path through which the nozzle 20 moves.

The guide unit 40 according to the first embodiment may be a straight line guide mounted in the frame 10 and including a guide hole 41 having a diameter corresponding to that of the nozzle 20 and a predetermined width at which the nozzle 20 may move, such that the nozzle 20 moves in a state in which it is seated in the guide hole 41. That is, the guide unit 40 may include a straight line guide hole 41 so that the nozzle 20 may reciprocate in a straight line direction. This may be used in the case in which the object to be cleaned is to be cleaned in the straight line direction.

Referring to FIG. 6, a second embodiment of a guide unit according to the embodiment of the present invention is disclosed. That is, the guide unit of the air blower assembly according to the embodiment of the present invention may accurately guide the nozzle 20 to a portion of the object to be cleaned, by controlling a path through which the nozzle 20 moves.

The guide unit 40 according to the second embodiment may be a random guide mounted in the frame 10 and including a guide hole 41 having a diameter larger than that of the nozzle 20, such that the nozzle 20 moves in a state in which it is seated in the guide hole 41. Here, the guide hole 41 may have various shapes such as a circular shape, a polygonal shape, and the like.

This may be used in the case in which a specific portion of the object to be cleaned is to be repeatedly cleaned.

As set forth above, the air blower assembly according to the embodiment of the preset invention may be used, whereby foreign objects attached to a small-sized component, or the like, may be efficiently removed.

In addition, when air secured to a certain speed level is blown from the air blower, the foreign objects may be removed by a resonance phenomenon. Therefore, a foreign object removing device may be simplified and a cost required for manufacturing a product may be reduced.

While the present invention has been shown and described in connection with the embodiments, it will be apparent to those skilled in the art that modifications and variations can be made without departing from the spirit and scope of the invention as defined by the appended claims.

What is claimed is:

1. An air blower assembly comprising:
a frame; and
a nozzle fixed to the frame and having one end to be connected to a blower to remove foreign objects by air blowing to the other end, the nozzle being an elastic body moving freely by the air blowing.

2. The air blower assembly of claim 1, further comprising a length controlling unit controlling a length at which the nozzle moves.

3. The air blower assembly of claim 2, wherein the length controlling unit is a sliding member that has the nozzle fixedly mounted thereon and is mounted in the frame so as to move in a length direction of the nozzle.

4. The air blower assembly of claim 2, wherein the length controlling unit includes the sliding member including a through-hole having the nozzle inserted thereinto while penetrating therethrough, the nozzle being inserted into the through-hole while penetrating therethrough in a state in which it is fixed to the frame, and only the sliding member moving in a length direction of the nozzle.

5. The air blower assembly of claim 1, further comprising a guide unit guiding the nozzle along a path.

6. The air blower assembly of claim 5, wherein the guide unit is a straight line guide mounted in the frame and including a guide hole having a diameter corresponding to that of the nozzle and a predetermined width at which the nozzle moves, such that the nozzle moves in a state in which it is seated in the guide hole.

7. The air blower assembly of claim 5, wherein the guide unit is a random guide mounted in the frame and including a guide hole having a diameter larger than that of the nozzle, such that the nozzle moves in a state in which it is seated in the guide hole.

8. A foreign object removing device comprising:
a rail transferring an object to be cleaned; and
the air blower assembly of claim 1 mounted to blow air toward the object to be cleaned being transferred by the rail.

9. A foreign object removing device comprising:
a rail transferring an object to be cleaned; and
the air blower assembly of claim 2 mounted to blow air toward the object to be cleaned being transferred by the rail.

10. A foreign object removing device comprising:
a rail transferring an object to be cleaned; and
the air blower assembly of claim 3 mounted to blow air toward the object to be cleaned being transferred by the rail.

11. A foreign object removing device comprising:
a rail transferring an object to be cleaned; and
the air blower assembly of claim 4 mounted to blow air toward the object to be cleaned being transferred by the rail.

12. A foreign object removing device comprising:
a rail transferring an object to be cleaned; and
the air blower assembly of claim 5 mounted to blow air toward the object to be cleaned being transferred by the rail.

13. A foreign object removing device comprising:
a rail transferring an object to be cleaned; and
the air blower assembly of claim 6 mounted to blow air toward the object to be cleaned being transferred by the rail.

14. A foreign object removing device comprising:
a rail transferring an object to be cleaned; and
the air blower assembly of claim 7 mounted to blow air toward the object to be cleaned being transferred by the rail.
